(19) United States
(12) Patent Application Publication
(10) Pub. No.: US 2026/0061914 A1
(43) Pub. Date: Mar. 5, 2026

(54) SEAT BACK HEAD MODULE, SEAT BACK, AND SEAT

(71) Applicant: Adient US LLC, Plymouth, MI (US)

(72) Inventor: Marek Machác, Trencín (SK)

(21) Appl. No.: 19/314,085

(22) Filed: Aug. 29, 2025

(30) Foreign Application Priority Data
Aug. 30, 2024 (DE) 10 2024 208 280.5

(51) Int. Cl. B60N 2/853; B60N 2/882; B60N 2/885

(52) U.S. Cl. CPC B60N 2/853; B60N 2/882; B60N 2/885

(57) ABSTRACT

A seat back head module for upgrading a seat back of a vehicle seat may have at least a support frame, a seat back head shell fixedly connected to the support frame, a drive unit for tilt adjustment of the support frame together with the seat back head shell about a pivot axis extending substantially parallel to a transverse extension direction of the support frame, and at least one attachment interface for fastening the seat back head module to the seat back. The support frame may be pivotably mounted at the attachment interface. A seat back and a vehicle seat utilizing the seat back head module are also provided.

### FIELD

The invention relates to a seat back head module, in particular a seat back head module for upgrading a seat back of a seat, in particular a vehicle seat, as well as to a seat back and a seat, in particular a vehicle seat.

### BACKGROUND

DE 10 2012 015 344 A1 discloses a seat back structure for a vehicle seat having a tilt-adjustable seat back head, comprising a seat back frame and an auxiliary frame which is pivotably connected to the seat back frame about a pivot axis extending parallel to a transverse direction of the vehicle.

The invention is based on the object of improving a seat back head, in particular as a seat back head module of the kind referred to at the outset, in particular for upgrading a seat back of a seat, in particular a vehicle seat, and to provide a corresponding seat back and a corresponding seat, in particular a vehicle seat.

### SUMMARY

The object is achieved according to the invention by a seat back head module having the features of claim 1. With regard to the seat back, the object is achieved according to the invention by the features of claim 10, and with regard to the seat, by the features of claim 12.

The seat back head module according to the invention for upgrading, for example retrofitting, a seat back of a seat, in particular of a vehicle seat, comprises at least a support frame, a seat back head shell fixedly connected to the support frame, and a drive unit for tilt adjustment of the support frame together with the seat back head shell about a pivot axis extending substantially parallel to a transverse extension direction of the support frame, wherein the seat back head module comprises at least one attachment interface for fastening the seat back head module to a seat back, and the support frame is pivotably mounted at the attachment interface.

Because the seat back head module comprises at least a support frame, a seat back head shell connected to the support frame, and a drive unit for adjusting the tilt of the support frame together with the seat back head shell about a pivot axis extending parallel to a transverse extension direction of the support frame, a compact and easily integratable add-on module, for example a top-mounted module, can be provided. The seat back head module is, in particular, a pre-assemblable or pre-assembled unit that can be easily fastened to a seat back.

Because the seat back head module comprises at least one attachment interface for, for example, the releasable or non-releasable attachment of the seat back head module to a seat back, with the support frame pivotably mounted at the attachment interface, conventional and/or already used seat backs and/or seats can easily be upgraded. This can reduce assembly time and effort.

Advantageous embodiments that can be used individually or in combination with one another are the subject matter of the dependent claims.

At least the support frame and the seat back head shell may be designed as a pre-assemblable or pre-assembled top-mounted module. The seat back head module is designed as a retrofittable comfort module for the seat back. The seat back head module constitutes a seat back comfort module that can be mounted as a retrofit top-mounted module onto existing production seat structures. This enables a flexible and modular expansion of a seat without having to make structural changes to the seat assembly.

The seat back head module may be designed as a so-called plug-and-play module.

The pivot axis defines an integrated, active pivot point. The seat back head module allows adjustment of an upper seat back region, in particular a shoulder support and/or neck support, via an active, motor-driven pivot point. The active pivot point enables the seat back head shell to be moved in a targeted, comfort-enhancing manner. A pivot angle of the support frame relative to the seat back may be at least 10°, for example up to 20° or more.

The seat back head shell may be adjustable about a pivot axis extending parallel to a transverse extension of the support frame. The seat back head shell may comprise at least a central shell section for supporting a back region of an occupant, and two side wings for supporting a shoulder region of the occupant.

The seat back head shell may comprise at least one head restraint recess. This can simplify the integration of the seat back comfort module into an existing seat, for example, without having to change the position and/or design of an existing head restraint.

The side wings on the central shell section may be formed so as to extend upward and laterally outward in such a manner that the head restraint recess is formed by the side wings and an upper edge of the central shell section. This can improve the visual appearance of the seat back head shell.

The seat back head shell may, in particular, be of one-piece design. For example, the shell section and side wings may be formed integrally. The seat back head shell may, in particular, be formed as a padded part.

The support frame may comprise at least two lateral second frame members and a first frame member connecting the lateral frame members. The support frame may, for example, be substantially U-shaped. The support frame may be arranged with its inverted U-shape movable relative to the seat back via the attachment interface.

The seat back head shell may extend over a front side of the support frame. The seat back head shell may be arranged on the front side of the support frame and be fixedly connected thereto at least in the region of the first frame member of the support frame. For example, the seat back head shell may be connected to the support frame in a releasable or non-releasable manner. For example, the seat back head shell may be screwed, riveted, welded, and/or adhesively bonded to the support frame.

The drive unit may be arranged on a rear side of the support frame. The drive unit may comprise at least one electric motor, for example. The electric motor may be fastened to the seat back. The drive unit may comprise at least one gearbox coupled to the electric motor. The drive unit may comprise at least one threaded spindle which is coupled at one end to the first frame member and at the other end via the gearbox to the electric motor. By driving the electric motor, the threaded spindle can be moved relative to the gearbox. By retracting and extending the threaded spindle, the support frame can be pivoted about the pivot axis.

The attachment interface may comprise at least one attachment mounting plate for fastening the seat back head module to the seat back. The attachment interface may comprise at least one bearing plate projecting perpendicularly from the attachment mounting plate for pivotably mounting the support frame. The attachment mounting plate may be connected to the seat back fixedly and in a releasable or non-releasable manner. The bearing plate may comprise a pivot bearing.

The object is further achieved according to the invention by a seat back having a seat back head module with the above-mentioned features. The seat back comprises at least a seat back frame and a seat back head module connected to the seat back frame. A pivot axis of the seat back head module extends substantially above a mid-height of the seat back.

The seat back head module may, in particular, be designed as a screw-on module. A rear cover, in particular a seat back cover, may be held in a fixed position relative to the seat back. This can reduce the complexity of gap management. Gap bridging may be required only in the head restraint area. Gap closure may be achieved by an elastic, stretchable cover material.

At least one elastic cover material may be arranged between the seat back head shell and the head restraint. The cover material may be provided to enable continuous coverage during a pivoting movement of the seat back head shell.

A forced coupling between a head restraint and the seat back head module can be achieved via a control unit and/or software. This enables synchronized movement of both components and ergonomic adaptation to a user of the seat. The drive unit may be integratable into a seat control system. This can enable automated adjustment, for example, based on user profile data and/or driving conditions.

The drive unit can be activatable or activated by the user via an electric control element and/or via a seat control.

Furthermore, the object is achieved according to the invention by a seat, in particular a vehicle seat, comprising at least a seat part and a seat back with a seat back head module.

### DESCRIPTION OF THE FIGURES

The invention will be explained in greater detail below with reference to advantageous exemplary embodiments shown in the figures. However, the invention is not limited to these exemplary embodiments. In the drawings:

FIG. 1: shows, in a schematic representation, a vehicle seat with a longitudinal adjustment device according to the prior art,

FIG. 2: shows a perspective view of a seat back head module according to the invention,

FIG. 3: shows a perspective view of a seat back according to the invention with a seat back head module according to FIG. 1,

FIG. 4: shows a perspective rear view of the seat back according to the invention according to FIG. 3, and

FIG. 5: shows a perspective rear view of the seat back according to the invention with a cover.

### DETAILED DESCRIPTION

Parts that correspond to one another are provided with the same reference signs in all figures.

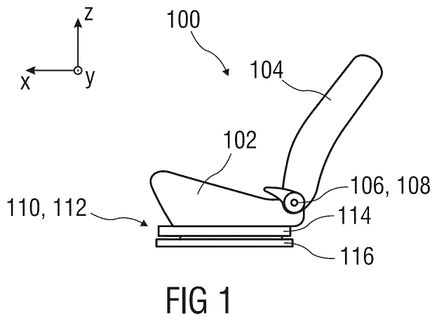

A vehicle seat 100 schematically illustrated in FIG. 1 as prior art will be described below using three spatial directions running perpendicular to one another. In the case of a vehicle seat 100 installed in a vehicle, a longitudinal direction x extends substantially horizontally and preferably parallel to a vehicle longitudinal direction, which corresponds to the usual direction of travel of the vehicle. A transverse direction y running perpendicular to the longitudinal direction x is likewise oriented horizontally in the vehicle and extends parallel to a vehicle transverse direction. A vertical direction z extends perpendicular to the longitudinal direction x and perpendicular to the transverse direction y. In the case of a vehicle seat 100 installed in the vehicle, the vertical direction z preferably extends parallel to a vehicle vertical axis.

The positional and directional indications used, such as front, rear, top, and bottom, refer to the viewing direction of an occupant seated in the vehicle seat 100 in a normal seating position, with the vehicle seat 100 installed in the vehicle in a use position suitable for transporting persons, with the seat back 104 in an upright position and oriented in the usual manner in the direction of travel. However, the vehicle seat 100 may also be installed or moved in a different orientation, for example transversely to the direction of travel. Unless described otherwise, the vehicle seat 100 is constructed to be mirror-symmetrical with respect to a plane perpendicular to the transverse direction y.

The seat back 104 may be pivotably arranged on a seat part 102 of the vehicle seat 100. For this purpose, the vehicle seat 100 may optionally comprise a fitting 106, in particular an adjustment fitting, rotary fitting, locking fitting, or tilting fitting.

The positional and directional indications used, such as radial, axial, and circumferential, for example, refer to a rotational axis 108 of the fitting 106. Radial means perpendicular to the rotational axis 108. Axial means in the direction of, or parallel to, the rotational axis 108.

The vehicle seat 100 may optionally comprise a longitudinal adjustment device 110. The longitudinal adjustment device 110 comprises, for example, a rail arrangement 112 having a first rail member 114 and a second rail member 116. The first rail member 114 is adjustable in the longitudinal direction x relative to the second rail member 116. The first rail member 114 is fastened to the seat part 102. The second rail member 116 is fastened to a structural member of a vehicle, for example a vehicle floor.

The first rail member 114 may, for example, be an upper rail, running rail, or slide. The first rail member 114 is assigned to the vehicle seat 100 and configured to support said vehicle seat 100. The second rail member 116 may be a lower rail that is fixedly connected, for example, to the floor of a vehicle.

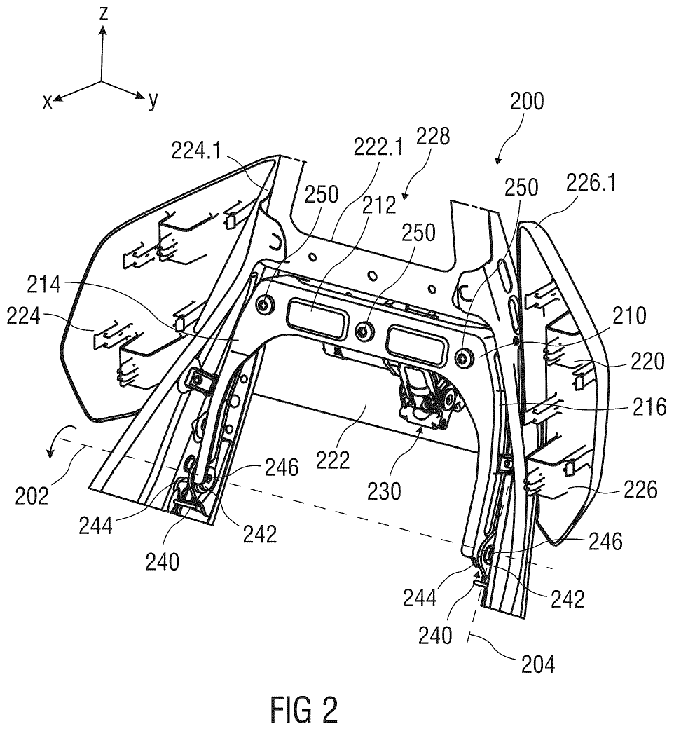

FIG. 2 shows a perspective view of a seat back head module 200 according to the invention.

The seat back head module 200 for upgrading a seat back 104 of a seat, in particular of a vehicle seat 100, comprises at least a support frame 210, a seat back head shell 220 arranged on the support frame 210, and a drive unit 230 for tilting the support frame 210 together with the seat back head shell 220. In particular, the drive unit 230 is configured to pivot the support frame 210 about a pivot axis 202 extending parallel to a transverse direction y.

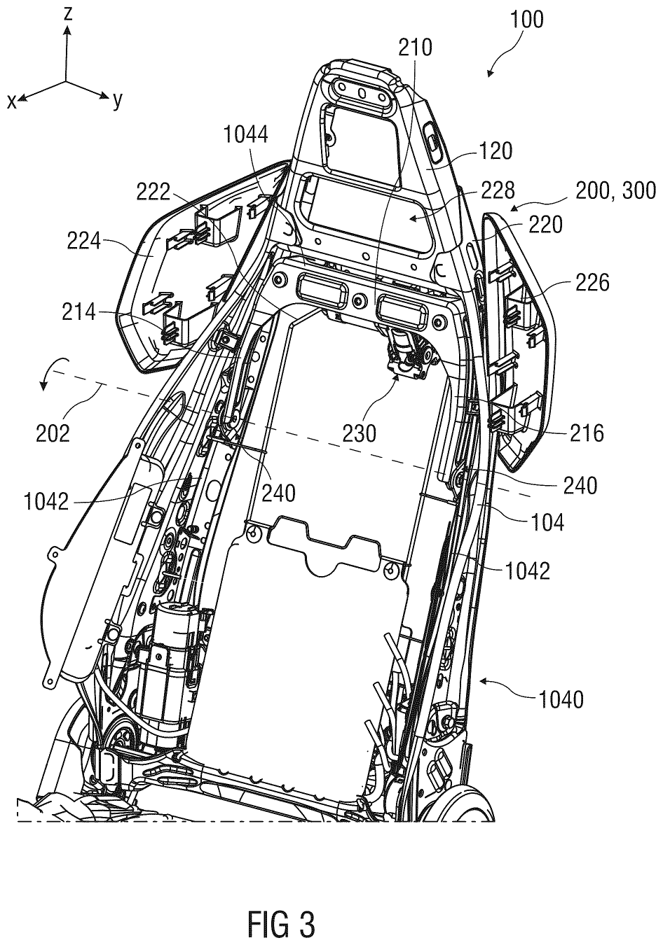

The seat back head module 200 comprises at least one attachment interface 240 for the releasable attachment, in particular fastening, of the seat back head module 200. In the exemplary embodiment shown, the seat back head module 200 comprises two lateral attachment interfaces 240 for fastening the seat back head module 200 to seat back side parts 1042 of a seat back frame 1040 of the seat back 104, as shown in FIG. 3. In particular, the support frame 210 is pivotable about the pivot axis 202 and relative to a plane 204 formed by the attachment interfaces 240. The support frame 210 is pivotably mounted at the respective attachment interface 240. The respective attachment interface 240 may comprise an attachment mounting plate 242, on which a pivot bearing 244 for pivotably mounting the support frame 210 is formed. The attachment interface 240 comprises at least one bearing plate 246 projecting perpendicularly from the respective attachment mounting plate 242 for pivotably mounting the support frame 210.

The support frame 210 is a base part which, in a mounted state 300 of the seat back head module 200 on the seat back 104 (shown in FIG. 3) is configured to pivotably hold the seat back head shell 220 on the seat back 104. The support frame 210 may be substantially U-shaped. The support frame 210 comprises, for example, a first frame member 212 arranged or extending transversely, for example a cross member, and two frame members 214, 216 projecting perpendicularly from the first frame member 212, for example legs. The lateral frame members 214, 216 are spaced apart from one another in the transverse direction y and arranged parallel to one another, with the first frame member 212 connecting the two lateral frame members 214, 216 to one another.

The seat back head shell 220 is connected to the support frame 210. For example, the seat back head shell 220 is fastened to the transversely extending first frame member 212 by a number of fastening members 250. The fastening members 250 may be screw connections, soldered connections, and/or welded connections.

The seat back head shell 220 is, for example, a support shell for supporting a back region and/or shoulder region of a user. A “seat back head” is understood to be an upper region of the seat back 104 facing an occupant of the vehicle seat 100. The seat back head shell 220 comprises at least a central shell section 222 which is fastened to the first frame member 212 of the support frame 210. In addition, the seat back head shell 220 comprises two side wings 224, 226 projecting laterally from the shell section 222.

The seat back head shell 220 comprises two lateral, i.e. laterally projecting, side wings 224, 226. As a result of this, the seat back head shell 220 has a shape that enhances comfort and safety. The shape of the side wings 224, 226 allows lateral support of a back region and shoulder region of a user.

In other words: arranged laterally adjacent to the central shell section 222 are two side wings 224, 226, also referred to as side bolsters, which each extend in the vertical direction z approximately up to half the length of the side frame members 214, 216 of the support frame 210.

The seat back head shell 220 comprises a head restraint recess 228. The side wings 224, 226 are arranged on the central shell section 222 so as to project upward and laterally in such a manner that the head restraint recess 228 is formed by the side wings 224, 226 and an upper edge 222.1 of the shell section 222. The side wings 224, 226 and the upper edge 222.1 may form an upwardly open U-shape or C-shape. The head restraint recess 228 is, for example, of U-shaped or C-shaped design. The head restraint recess 228 may be formed in the shape of a collar.

For example, upper wing tips 224.1, 226.1 of the side wings 224, 226 are spaced apart from one another in the transverse direction y and form a recess, i.e. the head restraint recess 228, between them. In this case, by means of the head restraint recess 228 an attachment region for the head restraint 120 (shown in FIG. 3) to the seat back can be ergonomically formed. Furthermore, the head restraint recess 228 enables a visually homogeneous transition to the seat back.

Viewed in the vertical direction z, the seat back head shell 220 covers an upper half of the support frame 210. In this arrangement, portions of the side wings 224, 226 and portions of the central shell section 222 extend above the upper, i.e. first, frame member 212. In the mounted state, the central shell section 222 may completely cover the first frame member 212 of the support frame 210.

In the vertical direction z, the central shell section 222 extends from the upper, first frame member 212 along the two lateral, second frame members 214, 216. For example, the central shell section 222 extends from the first frame member 212 along each of the two lateral, second frame members 214, 216 to approximately half of their length.

The side wings 224, 226 are dimensioned in the transverse direction y in such a manner that they each project laterally beyond the second frame members 214, 216 of the support frame 210. The side wings 224, 226 are dimensioned in the vertical direction z in such a manner that they each extend beyond the first frame member 212 of the support frame 210.

The seat back head shell 220 may be of one-piece design. For example, the seat back head shell 220 may be a plastic shell and/or a metal shell.

The seat back head module 200 is, in particular, a unit that can be pre-assembled or is pre-assembled, which can be fastened to the seat back 104 in a simple manner. The seat back head module 200 according to the invention can be tested for its functionality independently of the seat back 104 as an add-on module for upgrading a seat back 104.

The seat back head module 200 can be mounted as an upgrade module or attachment module for comfort adjustment onto existing production structures of vehicle seats 100. The attachment interfaces 240 may be fastened to different seat structures by releasable or non-releasable connection types. For example, the seat back head module 200 may be fastened to seat structures by screw connections.

Effective comfort adjustment can be achieved by providing an active pivot bearing 244, for example an active pivot point.

A forced coupling between a head restraint 120 (shown in FIG. 3) and the seat back head module 200 can be effected via a control unit and/or software.

FIG. 3 shows a perspective view of a seat back 104 according to the invention with a seat back head module 200 in the mounted state 300 according to FIG. 1.

The seat back 104 comprises a seat back frame 1040 with at least two seat back side parts 1042 spaced apart from one another in the transverse direction y. The seat back frame 1040 may comprise at least one seat back upper part 1044 connecting the seat back side parts 1042. A head restraint 120 can be arranged on the seat back upper part 1044.

The pivot axis 202 extends parallel to the transverse direction y, in the present case at approximately half the height of the seat back frame 1040. The support frame 210, and therefore the seat back head shell 220, are adjustable in tilt relative to the seat back frame 1040 by means of the drive unit 230 about the pivot axis 202. In the installed position of the seat back head module 200 on the seat back 104, the support frame 210 and the seat back head shell 220 extend predominantly upward from the pivot axis 202.

In the exemplary embodiment shown, the seat back head module 200 comprises two lateral attachment interfaces 240 for fastening the seat back head module 200 to the seat back frame 1040. In particular, the support frame 210 is configured to be pivotable about the pivot axis 202 and relative to the seat back frame 1040 of the seat back 104. The support frame 210 is pivotably mounted at the respective attachment interface 240.

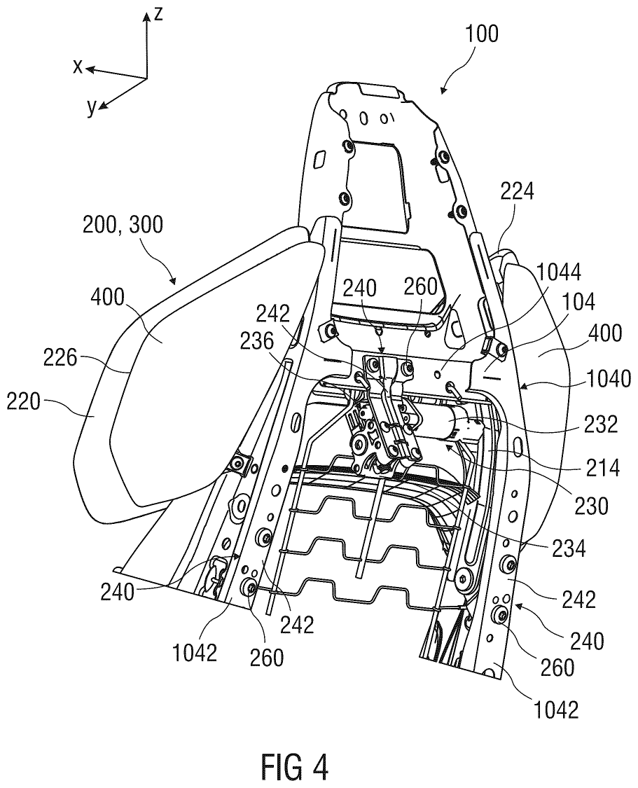

FIG. 4 shows a perspective rear view of the inventive seat back 104 according to FIG. 3.

Furthermore, the seat back head module 200 comprises a further attachment interface 240 for attaching or fastening the drive unit 230 to the seat back frame 1040 of the seat back 104. The respective attachment interface 240 of the seat back head module 200 may comprise an attachment holding plate 242 which is fastened to the respective seat back part by fastening members 260, for example screw members. In this case, an attachment interface 240 is assigned to each seat back side part 1042 of the seat back 104 and to the seat back upper part 1044 of the seat back 104.

The drive unit 230 may comprise an electric motor 232, a gear unit 234, for example a gear unit 234 with a gear housing, and a threaded member 236, for example a threaded spindle not shown in greater detail. In principle, all actuators known from the prior art can be combined into a pivot device. By means of the electric motor 232, a relative rotation between a spindle nut of the gear unit 234 and a relative rotation of the threaded spindle engaged with the spindle nut can be carried out. This means that the threaded spindle is displaceable relative to the spindle nut and therefore relative to the gear housing. The threaded spindle is displaceable along its spindle axis. One end of the threaded spindle is connected to the support frame 210. The end of the threaded spindle may be articulated to the support frame 210. The support frame 210 can act in the manner of a pivotable lever.

The gear unit 234 may be fastened to the seat back frame 1040, for example to the seat back upper part 1044. The gear unit 234 can be fastened to the seat back frame 1040 by means of a housing bracket. A pivot bearing 244 may be provided between the gear housing and the bracket.

A rear side of the respective side wings 224, 226 of the seat back head shell 220 may be provided with a pad 400. A front side of the seat back head shell 220 may be fully padded.

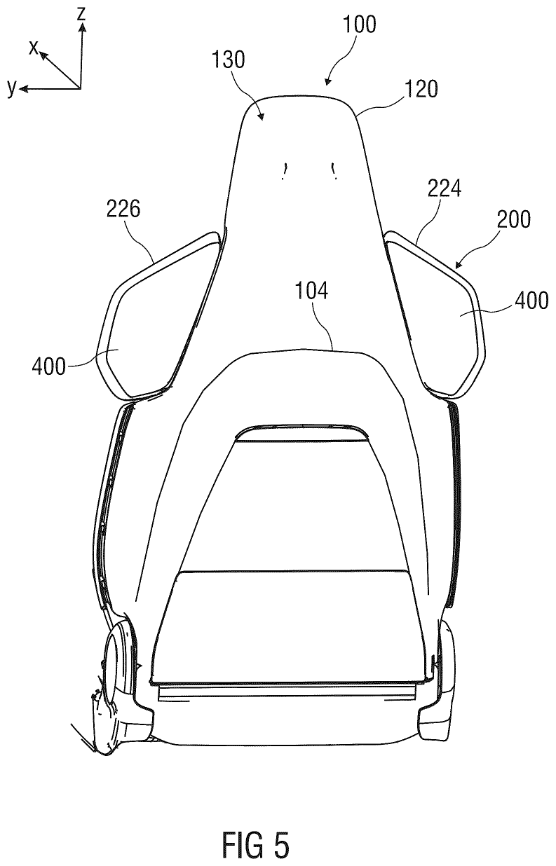

FIG. 5 shows a perspective rear view of the seat back 104 according to the invention with a cover 130. The cover 130 may be a trim member that covers both the head restraint 120 and the seat back 104. The side wings 224, 226 of the seat back head module 200 project laterally beyond the seat back 104. The seat back head shell 220, including the lateral shoulder region, is fully movable. A seat back cover with gap management can be provided, for example in the region of the head restraint 120. Gap closure can be achieved using stretch material.

### LIST OF REFERENCE SIGNS

100 vehicle seat
102 seat part
104 seat back
1040 seat back frame
1042 seat back side part
1044 seat back upper part
106 fitting
108 rotational axis
110 longitudinal adjustment device
112 rail arrangement
114 first rail member (upper rail)
116 second rail member (lower rail)
120 head restraint
130 cover
200 seat back head module
202 pivot axis
204 plane
210 support frame
212 to 216 frame member
220 seat back head shell
222 shell section
222.1 upper edge
224, 226 side wing
224.1, 226.1 wing tip
228 head restraint recess
230 drive unit
232 electric motor
234 gear unit
236 threaded member
240 attachment interface
242 attachment mounting plate
244 pivot bearing
246 bearing plate
250 fastening member
260 fastening member
300 mounted state
400 pad
X longitudinal direction
y transverse direction
Z vertical direction

What is claimed is:

1. A seat back head module for upgrading a seat back of a vehicle seat, characterized by at least:
a support frame,
a seat back head shell fixedly connected to the support frame,
a drive unit for tilt adjustment of the support frame together with the seat back head shell about a pivot axis extending substantially parallel to a transverse extension direction of the support frame, and
at least one attachment interface for fastening the seat back head module to the seat back,
wherein the support frame is pivotably mounted at the attachment interface.

2. The seat back head module as claimed in claim 1, characterized in that at least the support frame and the seat back head shell are configured as a preassemblable or preassembled add-on module.

3. The seat back head module as claimed in claim 1, characterized in that the seat back head shell comprises at least a central shell section and two side wings projecting laterally from the central shell section.

4. The seat back head module as claimed in claim 1, characterized in that the seat back head shell comprises at least one head restraint recess.

5. The seat back head module as claimed in claim 4, characterized in that the side wings are arranged on the central shell section so as to extend upward and laterally outward in such a manner that the head restraint recess is formed by the side wings and an upper edge of the central shell section.

6. The seat back head module as claimed in claim 1, characterized in that the support frame comprises at least two lateral second frame elements and a first frame element connecting the lateral frame elements.

7. The seat back head module as claimed in claim 6, characterized in that the seat back head shell is arranged on a front side of the support frame and is fixedly connected thereto at least in the region of the first frame element of the support frame.

8. The seat back head module as claimed in claim 6, characterized in that the drive unit is arranged on a rear side of the support frame and comprises at least one electric motor, a gearbox, and a threaded member which is coupled at one end to the first frame member and at the other end via the gearbox to the electric motor.

9. The seat back head module as claimed in claim 1, characterized in that the attachment interface comprises at least one attachment mounting plate for fastening to the seat back, and a mounting plate projecting perpendicularly from the attachment mounting plate for pivotably mounting the support frame.

10. A seat back for a vehicle seat comprising at least one seat back frame and a seat back head module connected to the seat back frame as claimed in claim 1, wherein the pivot axis of the seat back head module extends substantially above a mid-height of the seat back.

11. The seat back as claimed in claim 10, characterized in that the drive unit of the seat back head modules fastened to the seat back frame.

12. A vehicle seat comprising at least one seat part and a seat back as claimed in claim 10.
